(19) United States
(12) Patent Application Publication
(10) Pub. No.: US 2015/0291475 A1
(43) Pub. Date: Oct. 15, 2015

(54) BACTERIAL CELL WALLS AS VISCOSITY MODIFYING ADMIXTURES OF CONCRETE

(71) Applicant: Routing Pei, San Antonio, TX (US)

(72) Inventor: Routing Pei, San Antonio, TX (US)

(21) Appl. No.: 14/680,986

(22) Filed: Apr. 7, 2015

Related U.S. Application Data
(60) Provisional application No. 61/976,311, filed on Apr. 7, 2014.

(51) Int. Cl. C04B 24/38; C04B 28/04

(52) U.S. Cl. CPC C04B 24/38; C04B 28/04

(57) ABSTRACT

Embodiments are directed towards the use of bacterial cell walls as a viscosity modify admixture (VMA) of concrete.

This application claims priority to U.S. Provisional Patent Application 61/976,311 filed Apr. 7, 2014, which is incorporated herein by reference in its entirety.

### BACKGROUND

This invention relates to the fields of microbiology and materials science, more specifically the use of bacterial cell walls as viscosity modifying admixtures.

Viscosity modifying admixtures (VMAs) are widely used in the construction industry to enhance the stability and cohesion of fresh concrete and ensure high resistance to water dilution and bleeding in cement-based systems such as grout and self-compacting concrete (Khayat, Cement Concrete Comp, 20 (1998) 171-188). Many commonly used VMAs, including welan gum, diutan gum, cellulose ethers, starch, and chitosan, are long chain polysaccharides. Both welan gum and diutan gum are bacterial extracellular polysaccharides produced in aerobic fermentation (Sonebi, Cement Concrete Res, 36 (2006) 1609-18; Phyffereon et al., First North American Conference on the Design and Use of Self-Consolidating Concrete, 2002, 147-152). Cellulose ethers are derived from cellulose, the major components of plant cell walls (Patural, et al., Cement Concrete Res, 41 (2011) 46-55). Chitosan is the major component of the exoskeleton of crustaceans (such as crabs and shrimp) and cell walls of fungi (Alvarez et al., J Appl Polym Sci, 120 (2011) 242-52). These polysaccharide VMAs are biopolymers with shear thinning properties whereby apparent viscosity decreases or increases in response to application or removal of shear force, respectively. Their shear thinning property is due to the long chain chemical structures, which, at low shear rates, intertwine and entangle to increase viscosity and, at high shear rate, align along the flow direction and act as lubricant to lower viscosity (Khayat, Cement Concrete Comp, 20 (1998) 171-88).

Currently, the common polysaccharide VMAs in the market are costly. According to a market research report, cellulose ethers even with the minimal dosage are responsible for more than 20% of the cost of the finished products (Sowmya, Dry Mix Mortar Additives, Market Report of Frost & Sullivan (2007)). Both welan gum and diutan gum, though highly effective, are produced after aerobic fermentation of natural and genetically modified bacteria, respectively, and are among the most expensive cement admixtures currently in use. One report estimates that they are at least two times as costly as cellulose ethers (Plank, Appl Microbiol Biot, 66 (2004) 1-9). In comparison, chitosan is estimated to be 75% more costly than cellulose ethers. As a result, there have been continued efforts to search for additional cost effective VMAs.

### SUMMARY OF THE INVENTION

Certain embodiments are directed to concrete mixtures comprising a viscosity modifying agent (VMA) comprising bacterial cell walls or peptidoglycans isolated therefrom. Certain aspects are directed to flowable concrete mixtures. In a further aspect a flowable concrete composition comprises: (1) cement, (2) an aggregate, (3) water, and (4) bacterial cell walls or peptidoglycans isolated therefrom. In certain aspects the bacterial cell walls are isolated from Gram-positive bacteria. In further aspects the Gram-positive bacteria is Bacillus subtilis. In other aspects the source of the cell walls may be other Gram positive bacteria, including, but not limited to those listed in Table 1. In some embodiments the VMA is purified peptidoglycan from Bacillus subtilis or one of the bacteria in Table 1. In yet another the VMA may be a peptidoglycan isolated from a recombinant organism.

Certain embodiments of the invention relate to methods of modifying the viscosity of concrete mixtures, that method comprising admixing bacterial cell walls as a viscosity modifying agent (VMA). In some embodiments the bacterial cells walls are added at a concentration of 0.05, 0.10, 0.20, 0.30, 0.40, to 0.50% net weight, including all values and ranges there between.

Certain embodiments of the invention include a mixture of bacterial cell walls and a superplasticizer. In some embodiments bacterial cell walls are added to a cement paste in the presence of the 0.25% to 0.75% (by weight of cement) commercial superplasticizer. In some embodiments that superplasticizer is Superplasticizer 1.

In some embodiments the bacterial cell walls are hydrolyzed. In one aspect the hydrolysis is performed using lysozyme under appropriate conditions. In certain aspects hydrolysis can be acid or alkali hydrolysis.

Certain embodiments of the invention add cell walls as a concrete admixture to improve the mechanical performance of concrete. The bacterial cell walls are known to mediate microbial induced carbonate precipitation, a process in which CaCO₃ is formed from Ca²⁺ ions and dissolved CO₂. Consistent with such knowledge, incorporation of bacterial cell walls increased carbonation of Ca(OH)₂ and formation of CaCO₃ in concrete. Furthermore, the bacterial cell walls significantly increased compressive strengths of concrete by 15% while also decreased porosity at 28 days of curing. Assay for CaCO₃ precipitation in vitro indicated that bacterial cell walls, but not dead cells, accelerated carbonation of Ca²⁺ ions in Ca(OH)₂ solution. Since CaCO₃ formed can fill up the void, decrease the porosity, and increase the compressive strength in concrete, bacterial cell walls could act as a promising concrete admixture with benefits in enhancing mechanical performance and improving other carbonation-related properties. In some embodiments the concentration of cell walls added are added at concentrations of 0.3 mg/ml to 4.0 mg/ml.

In some embodiments the cell wall component is Pseudopeptidoglycan. Pseudopeptidoglycan (also known as pseudomurein) is a major cell wall component of some archaea that differs from bacterial peptidoglycan in chemical structure, but resembles eubacterial peptidoglycan in morphology, function, and physical structure. The basic components are N-acetylglucosamine and N-acetyltalosaminuronic acid (peptidoglycan has N-acetylmuramic acid instead), which are linked by β-1,3-glycosidic bonds. Lysozyme, a host defense mechanism, is ineffective against organisms with pseudopeptidoglycan cell walls. Lysozyme can break β-1,4-glycosidic bonds to degrade peptidoglycan; however, pseudopeptidoglycan has β-1,3-glycosidic bonds, rendering lysozyme useless.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is the Gram positive bacterium Bacillus subtilis and its composition of cell walls.

FIG. 2A-2E is chemical structures including the backbone and side chain (R) of (A) peptidoglycan, (B) starch, (C) welan or diutan gum, (D) cellulose ethers, and (E) chitosan.

FIG. 3A-3B is (A) the coaxial viscometer and (B) the chamber and spindle used for viscosity measurement.

FIG. 4A-4D is the apparent viscosity as a function of shear rate of cement paste amended with bacterial cell walls of various concentrations (0, 0.068%, or 0.34%) and W/C of (A) 0.36, (B) 0.40, (C) 0.44, or (D) 0.5.

FIG. 5A-5D is the percentage of apparent viscosity increases over control cement without bacterial cell walls at the shear rate of (A) 17, (B) 20.4, (C) 28, or (D) 34 s⁻¹.

FIG. 6A-6C is the apparent viscosity as a function of shear rate of cement paste and bacterial cell wall dosage of (A) 0%, (B) 0.068%, and (C) 0.34%.

FIG. 7 is the resistance to changes of W/C R_{W/C} for W/C (A) 0.40 vs 0.36, (B) 0.44 vs 0.36, (C) 0.50 vs 0.36, and (D) resistance to changes of shear rates.

FIG. 8 is the effect of hydrolysis on the viscosity of bacterial cell walls. Bacterial cell walls, hydrolyzed bacterial cell walls and diutan gum were incorporated at 0.02% into cement paste of W/C 0.4.

FIG. 9A-9B is the effect of SP of dosage (A) 0.25%, (B) 0.75%, amended together with 0.34% bacterial cell walls in cement paste of W/C 0.4.

FIG. 10 is a model of peptidoglycan arrangement in cell wall of Bacillus subtilis according to (Hayhurst et al., Proc Natl Acad Sci USA, 105 (2008) 14603-608). The end of the “rope” shown is composed of a small numbers of strands of polysaccharide backbones cross-linked by short peptide side chains.

FIG. 11 is compressive strength at day 7 and 28 curing for cement mortar specimens amended with cell walls of B. subtilis at 0.33 mg/ml (1×) or 3.3 mg/ml (10×) concentration (cement:sand=2:3 (volume), W/C=1:1 (volume), specimens 2×2×2 in). All experiments were performed at least three times and the results are shown as means±standard deviation. Asterisks (*) indicate significant difference from the control specimens (without B. subtilis cell wall) with 95% confidence interval.

FIG. 12 is compressive strength at day 7 and 28 curing for cement mortar specimens amended with dead cells of B. subtilis of 0.33 mg/ml (1×) or 33.3 mg/ml (100×) concentration (cement:sand=2:3 (volume), W/C=1:1 (volume), specimens 2×2×2 in). All experiments were performed at least three times and the results are shown as means±standard deviation. Asterisks (*) indicate significant difference from the control specimens without dead cells with 95% confidence interval.

FIG. 13 is compressive strength at day 7 and 28 curing for cement mortar specimens amended with live B. subtilis cells of 0.33 mg/ml (1×) or 33.3 mg/ml (100×) concentration (cement:sand=2:3 (volume), W/C=1:1 (volume), specimens 2×2×2 in). All experiments were performed at least three times and the results are shown as means±standard deviation.

FIG. 14 is effects of individual components of urea-CaCl₂ liquid media on compressive strength (cement:sand=2:3 (volume), W/C=1:1 (volume), specimens 2×2×2 in). The Y axis is expressed as the percentage of compressive strengths of the concrete specimens incorporate with individual components of the of urea-CaCl₂ culture media (indicated on the X axis) relative to that of control concrete specimens incorporated with water. All experiments were performed at least three times and the results are shown as means±standard deviation.

FIG. 15 is porosity of cement mortar specimens amended with or without the cell wall of B. subtilis of 0.33 mg/ml (1×) concentration. Asterisks (*) indicate significant difference from the control specimens (without B. subtilis cell wall) with 95% confidence interval.

FIG. 16A-16B is in vitro precipitation of CaCO₃ from the (A) CaCl₂ (7.5 mM) or (B) Ca(OH)₂ (0.94 mM) solution in the presence of the dead cells or cell walls of Bacillus subtilis. The results are representative of at least 5 experiments.

FIG. 17A-17C is measurement of CaCO₃ mineralization in ground 7 day-cured cement specimens. (A) Representative X-ray diffraction results at a continuous scanning rate of 2_{—} min_{—}1; (B) CaCO₃ crystal formation in the presence of cell walls of Bacillus subtilis, as visualized using scanning electron microscopy at 5000× magnification; and (C) energy dispersive X-ray analysis of mineralogical composition of the CaCO₃ crystal formed.

### DETAILED DESCRIPTION

Certain embodiments are directed to a cement composition/slurry. The composition can include cement, bacterial cell walls or peptidoglycans isolated therefrom, an optional additive, and a sufficient amount of water. Bacterial cell walls can be used as a cost effective VMA. First, bacterial cell walls/peptidoglycans are highly abundant in Gram positive bacteria such as Bacillus subtilis. Peptidoglycan constitutes more than 50% of the dry weight of cell walls of Bacillus subtilis and cell walls of Bacillus subtilis constitutes 20 to 70% of the dry weight of the bacterial cell. Second, due to their high abundance, it is relatively easy to extract or isolate bacterial cell walls. The extraction process does not require fermentation and involves grinding and centrifugation that are easy to perform and scale up to mass manufacturing with low cost. Third, lysozyme hydrolysis can be used to reduce the molecular weight of bacterial cell wall and optimize its properties. In some aspects the hydrolysis procedure using lysozyme can be replaced by the much cheaper acid (Räsänen and Arvilommi, Infect Immun, 34 (1981) 712-17) or alkali (Cheong et al., Arch Pharm Res, 22 (1999) 515-19) hydrolysis. Fourth, because other Gram positive bacteria have similar cellular structures to Bacillus subtilis, they could also be used as sources of bacterial cell walls/peptidoglycans.

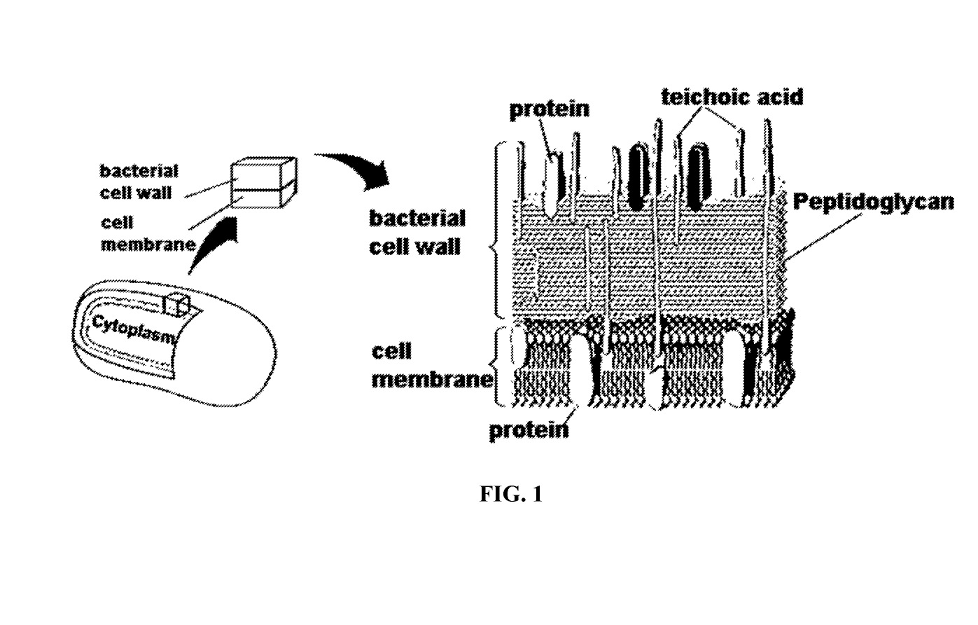

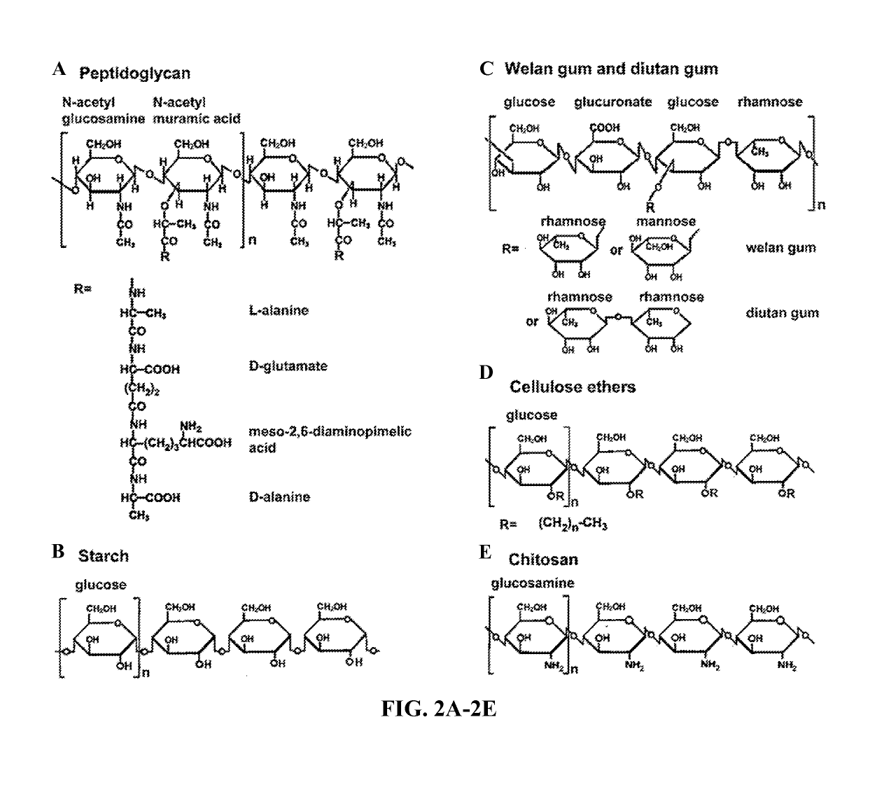

Peptidoglycan is a biopolymer found as the major component in bacterial cell walls having a chemical structure similar to the polysaccharide VMAs. In Gram positive bacteria such as Bacillus subtilis, peptidoglycan comprises more than 50% of the dry weight of cell walls, forming a layer of 15-30 nm thick with covalent links to other polymers including teichoic acids and proteins to enclose the inner cell membrane and cytosol (FIG. 1) (Atrih et al., J Bacteriol, 181 (1999) 3956-66). Peptidoglycan is made up of polysaccharide (glycan) strands of repeating units of disaccharide, N-acetyl glucosamine-N-acetyl muramic acid, cross-linked via short peptide side chains (Hayhurst et al., Proc Natl Acad Sci USA, 105 (2008) 14603-608)(FIG. 2A). The chemical structures of the commonly used polysaccharide VMAs including starch, welan gum, diutan gum, cellulose ethers, and chitosan (FIG. 2B-2E) and that of peptidoglycan all contain long chain polysaccharide backbones of repeating saccharide units, even though the minimal repeat units contain 2, 1, 4, 4, 1, and 1 six-member ringed monosaccharides for peptidoglycan, starch, welan gum, diutan gum, cellulose ethers, and chitosan, respectively.

The structure of peptidoglycan resembles those of welan and diutan gum in that they are all anionic under alkaline pH, such as in concrete, due to the negatively charged carboxyl groups (Plank et al., J Appl Polym Sci, 116 (2010) 2913-19). The molecular weight of peptidoglycan (at least 1×10⁷ Daltons) (Chetty et al., Infect Immun, 38 (1982) 1010-19) is most similar to diutan gum (2.88 to 5.18×10⁶ Daltons), which is the highest among the abovementioned polysaccharide VMAs (Phyffereon et al., First North American Conference on the Design and Use of Self-Consolidating Concrete, 2002, pp. 147-52). Longer backbone strands and larger side chains of diutan gum are responsible for the higher viscosity of diutan gum than that of other polysaccharide VMAs (Sonebi, Cement Concrete Res, 36 (2006) 1609-18).

In the original bacterial phyla, the Gram-positive organisms made up the phylum Firmicutes, a name now used for the largest group. It includes many well-known genera such as Staphylococcus, Streptococcus, Enterococcus, Bacillus, Corynebacterium, Nocardia, Clostridium, Actinobacteria, and Listeria. It has also been expanded to include the Mollicutes, bacteria-like Mycoplasma that lack cell walls and cannot be Gram stained. Actinobacteria are the other major group of Gram-positive bacteria, which have a high guanine and cytosine content in their genomes (high G+C group). This contrasts with the Firmicutes, which have a low G+C content.

Both Gram-positive and Gram-negative bacteria may have a membrane called an S-layer. In Gram-negative bacteria, the S-layer is directly attached to the outer membrane. In Gram-positive bacteria, the S-layer is attached to the peptidoglycan layer. Unique to Gram-positive bacteria is the presence of teichoic acids in the cell wall. Some particular teichoic acids, lipoteichoic acids, have a lipid component and can assist in anchoring peptidoglycan, as the lipid component is embedded in the membrane.

In certain aspects the cement compositions include water to make cement slurry. The water can be fresh water or salt water (e.g., sea water). The amount of water in the cement composition can be from about 30, 40, 50, 60, 70, 80, 90% to 90, 100, 110, 120, 13, 140, 15, 170% by weight of cement (cement can include the composition containing cement, bacterial cell walls or bacterial peptidoglycans, and optionally one or more additive). The additive can be a lightening agent, an anti-foaming agent, a retardant, an accelerator, a dispersant, a fluid loss controlling agent, a surfactant, or a gas migration controlling agent, to name a few. In one exemplary embodiment of the present teachings, the additive is present in an amount of from about 0.1, 1, 10, 50, 100% by weight of cement (BWOC) to about 10, 50, 100, 150% BWOC, including all values and ranges there between. A gas migration controlling agent can include a composition having at least about 90% SiO₂, from about 0.5% to about 2.0% Al₂O₃, from about 0.2% to about 1.5% Fe₂O₃, from about 0.1% to about 0.5% CaO, from about 0.1% to about 1.5% Na₂O, from about 0.5% to about 2.0% K₂O, from about 0.5% to about 2.0% MgO, from about 0.1% to about 0.4% SO₃, and from about 0.5% to about 2.5% C. For example, the gas migration controlling agent can be MICROBLOCK, which can be purchased from Elkem Materials, P.O. Box 266, Pittsburgh, Pa. 15230-0266, Airport Office Park, Building 2, 400 Rouser Road, Moon Township, Pa. 15108-2749. In another example, the gas migration controlling agent can include a composition having at least latex particles. An example of a latex-based gas migration controlling agent is para gas, such as Schlumberger GAS BLOCK D600, which can be purchased from Schlumberger Oilfield Services located at 1325 S. Dairy Ashford Dr., Houston, Tex. 77077.

In certain aspects cement can be foam cement. The foam cement can include one or more types of gasses including nitrogen and/or air, in addition to other ingredients. In further aspects the cement can be hydraulic cement. Examples of hydraulic cements include, but are not limited to, Portland, posaloani, gypsum, aluminum, or silicon cements. In certain aspects a Portland cement can be one that is classified as class A, C, D, E, J, H, or G by the American Petroleum Institute (API).

A method for preparing the composition of the present teachings includes: (a) mixing cement with the bacterial cell walls or bacterial peptidoglycan(s), (b) adding additives if needed to water to make a water-additive mixture, and (c) mixing the product from step (a) with the product from step (b). Once the cement slurry has been prepared, the cement slurry can be applied to a desired location to cure and harden.

### Examples

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Strains and Preparation of Bacterial Cell Walls.

In certain embodiments Bacillus subtilis strain 168 (ATCC, Manassas, Va.), a well-studied Gram positive bacterium (Mastromei et al., BioGeocivil Engineering Conference, Delft, Netherlands 2008, pp. 104-106), was used as a source of bacterial cell walls. The bacterial cells were cultured in nutrient broth (Oxoid, Thermo Fisher Scientific, Pittsburgh, Pa.) at 37° C. and collected at the logarithmic growth stage by centrifugation. Bacterial cell walls were prepared as described in Pei et al. (Cement and Concrete Composites, 39 (2013), 122-30). Briefly, Bacillus subtilis cells were collected and disrupted by grinding in a mortar for 15 min with an equal volume of alumina. The disrupted cells were suspended in physiological saline solution (8.5 g/l NaCl) and centrifuged at 1000 to 2500×g in Eppendorf 5804R fixed angle centrifuge rotor at 4° C. for 20 min. The pellets were removed which contained alumina and unbroken cells. The supernatant was then centrifuged at 10,000 to 15,000×g for 20 min to separate the resulting supernatants, which contained cytosol, and the pellets, which contained bacterial cell walls. The pellets were weighed and re-suspended in physiological saline solution at an approximate concentration of 0.1 mg wet weight/ml and stored at −20° C. for further analyses. As controls, Gram positive Micrococcusluteus and negative bacteria Escherichia coli were cultured in Luriabroth (Thermo Fisher Scientific).

To prepare dead cells, cells were collected during the exponential growth phase, autoclaved at 120° C. for 30 min, centrifuged and re-suspended in physiological saline solution (8.5 g/l NaCl) to a concentration of 10⁸ cells/ml before being stored at −20° C. Bacterial cell walls were prepared as described by Mastromei et al. (Cement Concrete Res, 36 (2006) 1609-1618).

Preparation of Cement Mortar Specimens.

In certain embodiments bacterial cell walls of Bacillus subtilis are incorporated into cement paste specimens as part of the mixing water. For each W/C (0.36, 0.4, 0.44, and 0.5), bacterial cell walls were first suspended in deionized water for a total volume of 8 ml. To study whether the molecular weight of bacterial cell walls affect the viscosity, bacterial cell walls are pretreated with 0.67 mg/ml lysozyme from chicken egg white (Sigma-Aldrich, St. Louis, Mo.) in 0.375 ml STET buffer (10 mM Tris-HCl, pH 8.0, with 0.1 M NaCl, 1 mM EDTA, and 5% TRITON X-100) for 30 min at 37° C., followed by incubation in boiling water for 30 sec to inactivate lysozyme and addition of deionized water to a total volume of 8 ml. The bacterial cell walls in water are then sonicated for 60 min using Branson Ultrasonic Cleaners (Model 3510) for even distribution and dissolution. As a positive control with known VMA functions, diutan gum kindly supplied by CP Kelco Inc. (Atlanta, Ga.) was added in cement paste after dissolving in mixing water. Type I/II low alkali Portland cement manufactured by Alamo Cement Company (San Antonio, Tex.) was mixed for 30 seconds with 4 ml of mixing water containing bacterial cell walls or diutan gum, then for an additional 2 min with additional 4 ml solution. Where superplasticizers (SP) were studied, a commercial SP in powdery form called Superplasticizer 1 labeled as a sulfonated organic polymer manufactured by Fritz-Pak Corporation (Dallas, Tex.) was thoroughly mixed with cement before mixing water containing bacterial cell walls or diutan gum was added. SP dosages used were 0.25% and 0.75%, by weight of cement, which is within the range of dosages suggested by the manufacturer.

In certain aspects, cement mortar specimens (2×2×2 in) were prepared using type I ordinary Portland cement and sand (110 μm average grain size) sieved by No. 8 USA standard sieve with cement/sand ratio of 1:2 (volume ratio) and W/C ratio 0.68 (volume ratio). Cement mortar specimens were poured according to ASTM C-31 and cured at room temperature in water for 7 or 28 days. Bacterial reagents of various concentrations (3.3×10⁻³, 3.3×10⁻¹ and 3.3×10¹ mg/ml for live and dead B. subtilis cells; and 3.3×10⁻¹ and 3.3 mg/ml for cell walls of B. subtilis) were incorporated into the specimens as part of the mixing water to determine their effects on compressive strength, porosity and CaCO₃ formation. To provide nutrients for the bacteria, the liquid medium was included when live bacteria were incorporated. Thus, to be consistent, all other bacterial reagents were incorporated together with the liquid medium. The control specimens are amended with the liquid medium only (without the bacterial reagents). The liquid medium (urea-CaCl₂) contained the following components per 1000 ml of water: 3 g nutrient broth (Oxoid, Thermo Fisher Scientific), 20 g urea, 10 g ammonium chloride, and 2.12 g sodium bicarbonate (pH=8) and calcium chloride was added to a final concentration of 25.2 mM. To ensure that components of the liquid medium did not significantly affect physicochemical properties of cement mortar specimens, experiments were performed using specimens amended with individual constituents of the urea-CaCl₂ liquid medium. All experiments were performed at least three times.

Viscosity Measurement.

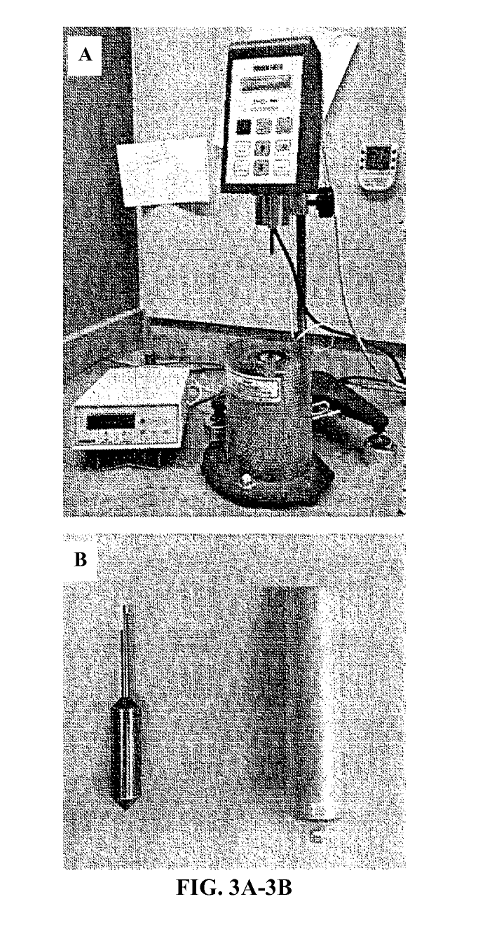

The viscosity of the cement paste amended with bacterial cell walls were measured at room temperature (22-25° C.) using the Brookfield viscometer (Model DV-II+Pro) (FIG. 3A) equipped with coaxial SC4-27 spindle (diameter 11.76 mm; side length 33.02 mm) and sample chamber (inner diameter 19.05 mm; depth 86.20 mm; sample volume 10.5 ml) (FIG. 3B) manufactured by Brookfield Engineering Labs., Inc. (Middleboro, Mass.). The process of viscometry is adapted from Nanthagopalan and Santhanam (Mater Struct, 43 (2010) 203-212). Briefly, upon adding the mixing water, the cement paste mixtures were manually stirred immediately and then poured into the cylindrical container and the spindle of the viscometer was inserted into the cement mixture for measurement. The torque, apparent viscosity, and shear stress were recorded at the shear rate of 17, 20.4, 28, and 34 s⁻¹. These shear rates have been frequently experienced in typical concreting processes like placing and casting and were applied one by one from low to high. At each shear rate, readings were recorded upon stabilization.

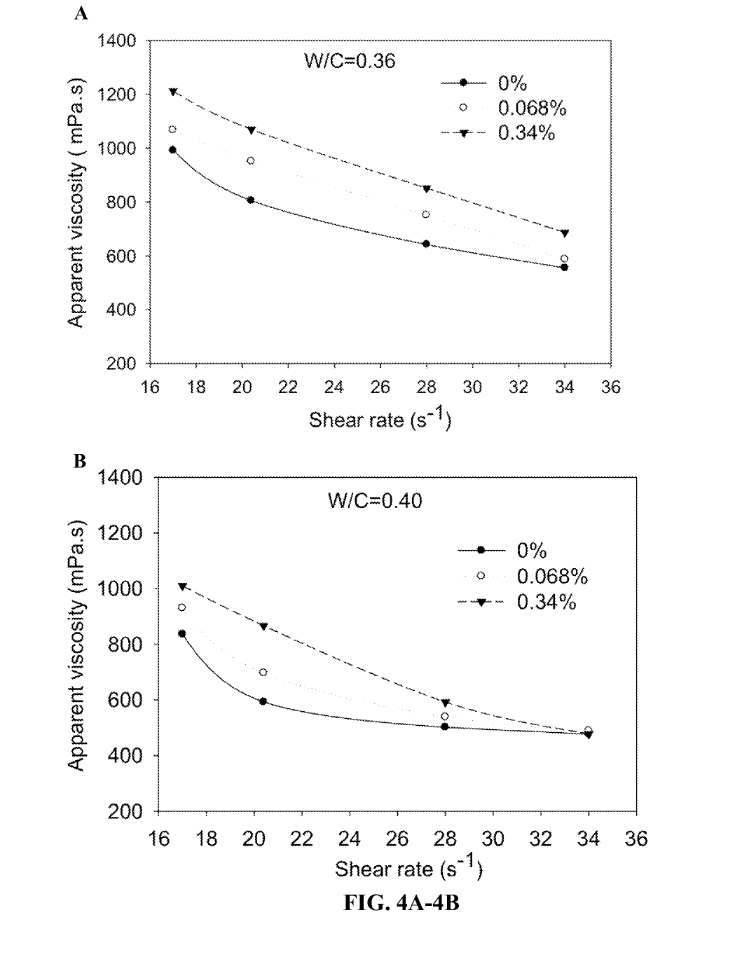

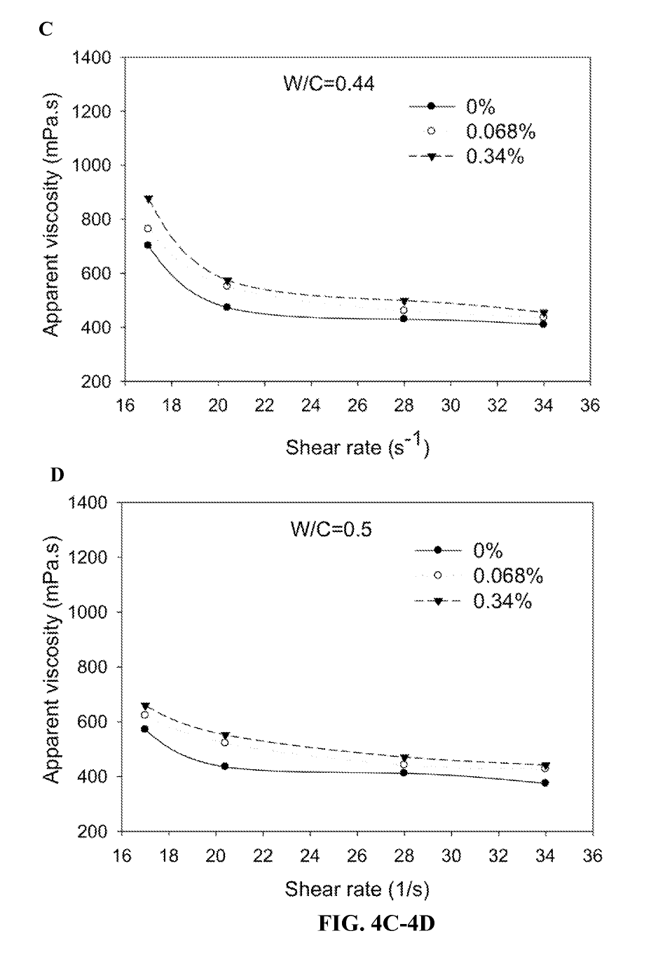

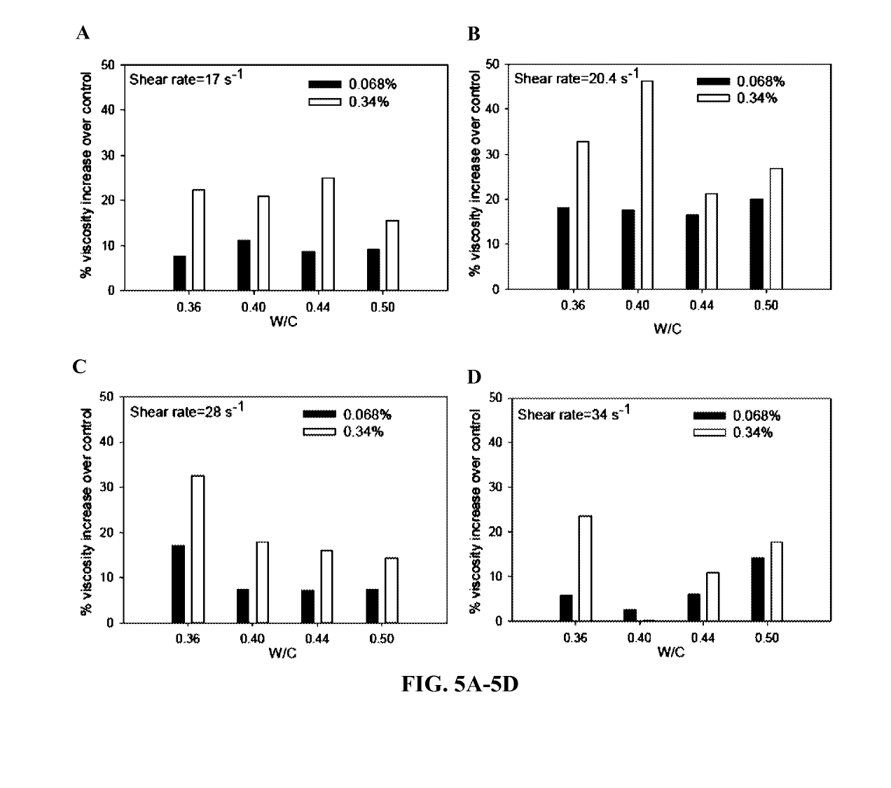

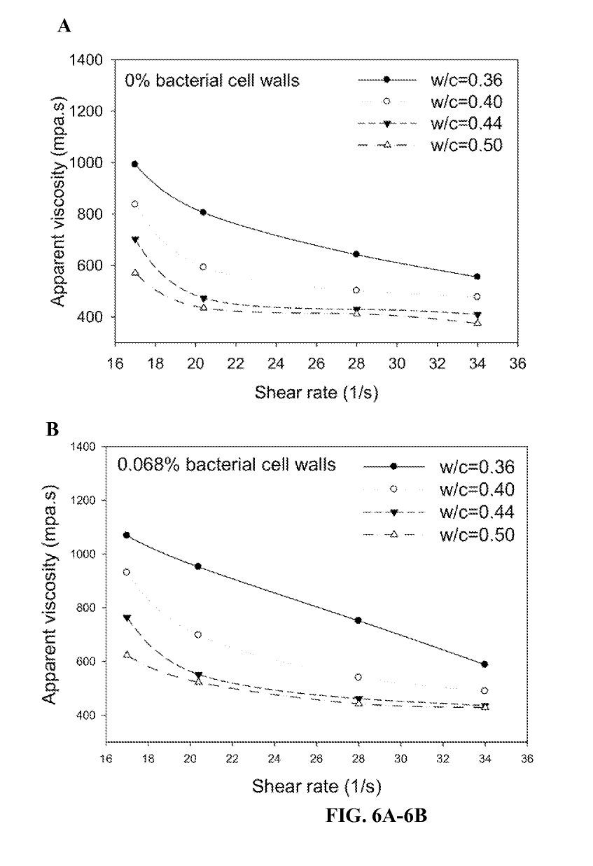

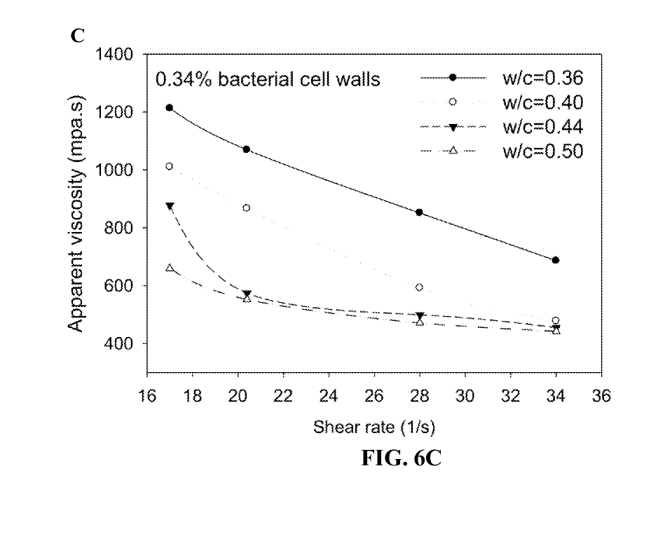

Bacterial cell walls of Bacillus subtilis as VMAs. Viscometry of cement paste amended with bacterial cell walls was performed. The results of variation of apparent viscosity as a function of shear rate for cement paste with various dosages of bacterial cell walls (0, 0.068%, or 0.34%, as wet weight of bacterial cell walls/weight of mixing water) and W/C (0.36, 0.4, 0.44, or 0.5) are shown in FIG. 4. For all W/C and bacterial cell wall dosages, the apparent viscosity was found to decrease with the increase of shear rate, which is characteristic of the shear thinning behavior of VMA modified cement system. In addition, the apparent viscosity of cement paste increased with the amendment of bacterial cell walls. For W/C of 0.36, at the shear rate of 17 s⁻¹, amendment with 0.068% bacterial cell walls caused an increase of 7.6% and amendment with 0.34% bacterial cell walls caused a larger viscosity increase of 22.2% (FIG. 5A). The same trend was also observed for other shear rates 20.4, 28 and 34 s⁻¹ (FIG. 5B-5D). For W/C 0.4, at the shear rate of 17 s⁻¹, amendment of 0.068% bacterial cell walls caused the viscosity of cement paste to increase by 11.2%, and amendment of 0.34% bacterial cell walls caused an increase of 20.8% (FIG. 5A); as the shear rate increased to 34 s⁻¹, the effects of increasing dosage of bacterial cell walls on viscosity increase diminished (FIG. 5D). For W/C 0.44 and 0.5, the viscosity of cement paste amended with either dosage of bacterial cell walls was increased, compared to the control cement (FIG. 5). In addition, keeping the dosage of bacterial cell walls constant, results of apparent viscosities as a function of shear rates and W/C of cement paste are shown in FIG. 6. Taken together, the results demonstrate that bacterial cell walls behaved as a VMA with shear thinning property whose viscosity is positively correlated with the dosage of bacterial cell walls.

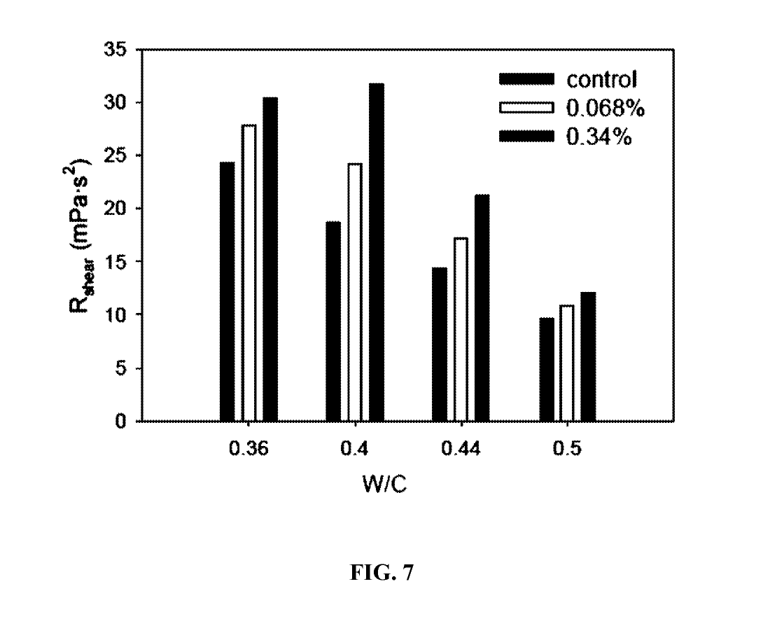

To quantify the sensitivity of the apparent viscosity of cement paste to change of shear rate, a parameter Rshear (with the unit of mPa*s2) is defined as the absolute value of the slope of the linear regression line for the data of apparent viscosity as a function of shear rate. The linear regression analysis for obtaining the slope values was performed using the Microsoft Excel software on the data of apparent viscosity vs. shear rate shown in FIG. 4 at each W/C and bacterial cell wall dosage. In general, the resistance of apparent viscosity to change of shear rate Rshear increased with the increase of bacterial cell walls dosage at all W/C. For example, when W/C was increased from 0.36 to 0.4, the Rshear of cement pastes amended with 0.34% bacterial cell walls remained little changed, i.e., 30 and 31 mPa*s2 for W/C of 0.36 and 0.4, respectively, while that of control with no bacterial cell walls were dropped from 25 to 18 mPa*s2 (FIG. 7). This indicated that the shear rate had less effect on the viscosity of cement paste amended with 0.34% bacterial cell walls.

The Effects of Molecular Weight of Peptidoglycan on Viscosity of Cement Pastes and Comparison with Other VMAs.

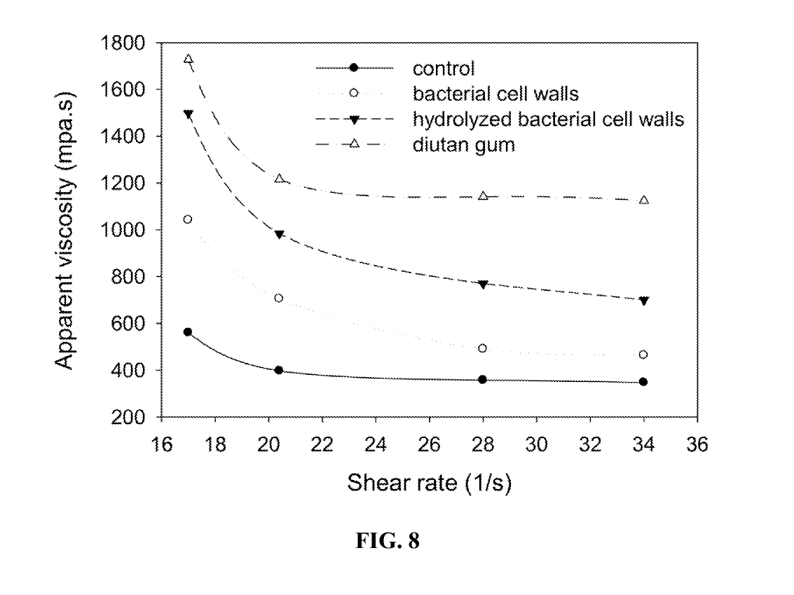

It is known that viscosity enhancing effects of starch and cellulose ethers depend on their molecular weights (Knaus and Bauer-Heim, Carbohydrate Polymers, 53 (2003) 383-94; Vieira et al., Cement Concrete Res, 35 (2005) 883-90). In addition, the fact that diutan gum has higher viscosity than welan gum is attributed to diutan gum being a larger molecule. It is not known whether the molecular weight of peptidoglycan affect its rheological property. Thus, the molecular weight of peptidoglycan was modified using lysozyme treatment for 30 min at 37° C., which is a bactericidal reagent that degrades cell walls via hydrolysis of 1,4-β-linkages between N-acetyl muramic acid and N-acetyl glucosamine of the peptidoglycan backbone. Then the viscosity of cement paste of W/C 0.4 incorporating hydrolyzed bacterial cell walls was measured, in comparison with that of cement paste incorporating hydrolyzed bacterial cell walls. As controls, cement pastes amended with diutan gum or without any admixture were also measured. In accordance with the report that diutan gum incorporated had 0.02% dosage (as weight/weight of cement)(Sonebi, Cement Concrete Res, 36 (2006) 1609-18), the same dosage was used for hydrolyzed and unhydrolyzed bacterial cell walls (as wet weight/weight of cement, corresponding to 0.05% wet weight/weight of mixing water for cement paste with 0.4 W/C). Results indicated that the apparent viscosity of cement paste amended with no admixture, with unhydrolyzed bacterial cell walls, hydrolyzed bacterial cell walls, or diutan gum at the low shear rate of 17 s⁻¹ is 560, 1041, 1498, or 1727 mPa*s, respectively. Similar trend for the rank of apparent viscosities was also observed for higher shear rates (FIG. 8). Overall, the hydrolyzed bacterial cell walls with a lower molecular weight had higher viscosity than unhydrolyzed bacterial cell walls and the viscosity modifying effects of bacterial cell walls and hydrolyzed bacterial cell walls appeared to be comparable to that of diutan gum.

Performance of Superplasticizers (SP) Applied Together with Match Bacterial Cell Walls.

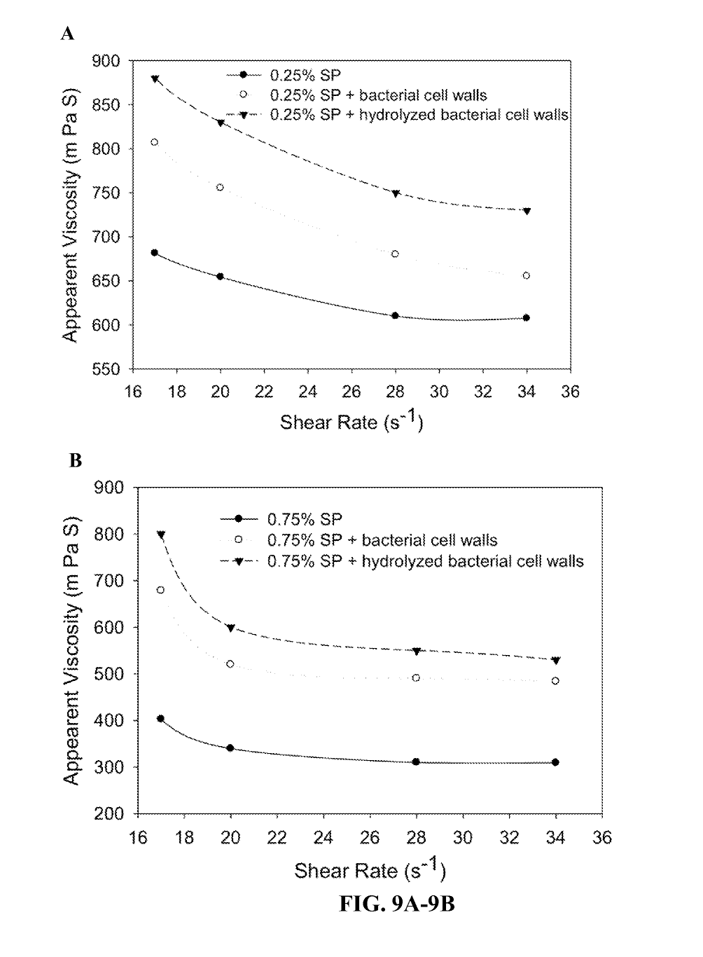

In cement based systems, VMAs are normally used together with a SP to get a stable and highly flowable cement mixture such as in self-consolidating concrete that can fill heavily reinforce space without need for vibration (Mehta and Monteiro, Concrete:microstructure, properties, and materials, 3rd ed., McGraw-Hill, New York, 2006). Since anionic VMAs such as diutan gum have the tendency to adsorb onto the surface of the cement particles and increase water demand, the need for using SP together is especially important. With peptidoglycan being anionic similar to diutan gum, we want to study the effect of SP together with bacterial cell walls. Thus bacterial cell walls were amended in cement paste in the presence of the 0.25% or 0.75% (by weight of cement) commercial SP called Superplasticizer 1. The presence of the commercial SP decreased the viscosity in a dose dependent manner that antagonized the viscosity enhancing activity of both hydrolyzed and unhydrolyzed bacterial cell walls (FIG. 9). This suggested that Superplasticizer 1 may be used together as a compatible SP for application of bacterial cell walls as a VMA.

Relationship Between Chemical Structure and Shear Thinning Property of Bacterial Cell Walls.

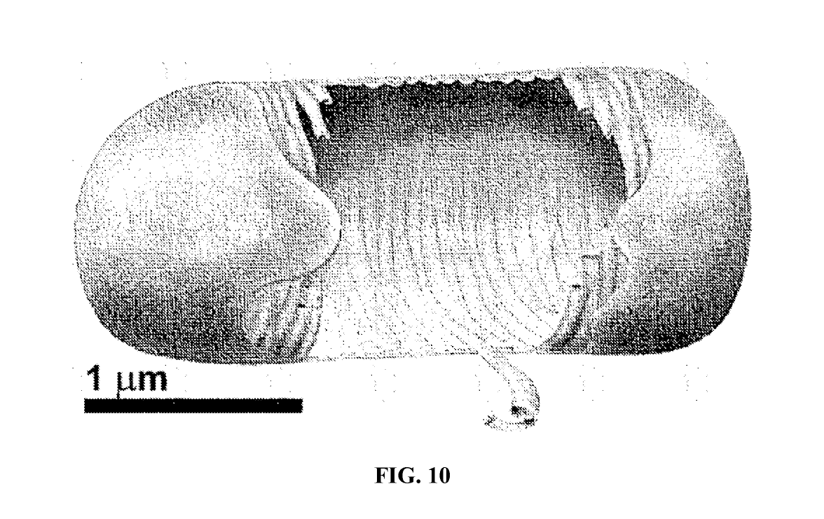

The shear thinning property of the commonly used polysaccharide VMAs such as welan gum, diutan gum, and cellulose ethers is dependent on their linear long chain structures via the following mechanisms: (1) adsorption, which is based on the function of the hydrophilic groups such as hydroxyl groups in the long chain to adhere to the water molecules; (2) association, due to the attractive forces among chemical groups in adjacent chains, further blocking the motion of water and causing formation of gel and increase in viscosity; (3) intertwining and aligning, i.e., the long chains intertwine at low shear rate to increase viscosity and align along the flow direction at high shear rate to act as lubricant and decrease viscosity. The results demonstrate that bacterial cell walls incorporated in cement paste also exhibited shear thinning properties. However, peptidoglycan in its native form in Gram positive bacterial cell walls forms a giant molecule with bag shape to enclose the cell content (Vollmer et al., FEMS microbiology reviews, 32 (2008) 149-67) (FIG. 2A). The extraction process for bacterial cell wall and the subsequent sonication treatment caused fragmentation of the peptidoglycan molecule and exposure of microstructure composed of long chains. It has been observed by Hayhurst et al. using atomic force microscopy that peptidoglycan in cell wall preparation of Bacillus subtilis contained polysaccharide strands up to 5 μm long which is longer than the cells (about 3 μm long). A peptidoglycan structure model was proposed in which the polysaccharide arranges as cables of coiled rope (Hayhurst et al, Proc Natl Acad Sci USA, 105 (2008) 14603-608) (FIG. 10). The “rope” forms when a small number of linear strands of polysaccharide composed of repeating disaccharide units are cross-linked by the short peptide side chains. This rope is then coiled into a left-handed helix to form the cable structure lining the inner surface of the cell wall (FIG. 10). The extraction process and ultrasonic treatment can break the bag-shaped macrostructure to release or expose the “rope” as loose polysaccharide strands, thereby exhibiting shear thinning property.

The Relationship Between the Molecular Weight and Viscosity of Bacterial Cell Walls.

It has been observed in polysaccharide VMAs that their viscosities are dependent on the molecular weights, which is dependent on the length of the backbone and size of side chains. Both cellulose ethers and starch of high molecular weight amended in cement paste can increase viscosity, while their hydrolyzed products with lower molecule weights have lower viscosity. Below a critical molecular weight, hydrolyzed product of starch lost the function to increase viscosity and behaved like a superplasticizer that decrease the viscosity of cement paste (Vieira et al., Cement Concrete Res, 35 (2005) 883-90). In addition, the higher viscosity of diutan gum than welan gum is due to the longer backbone chain and larger side chains of diutan gun which offer greater opportunity for entanglement and intertwining of long chains resulting in increase of viscosity. The molecular weight of peptidoglycan in its native form in bacterial cell walls has been estimated to be at least 1×10⁷ Daltons (Chetty et al., Infect Immun, 38 (1982) 1010-19), which is larger than those of diutan gum (2.88 to 5.18×10⁶ Daltons), welan gum (0.66 to 0.97×10⁶ Daltons), starch (1×10³ to 1×10⁵ Daltons), cellulose ethers such as hydroxyethyl methyl cellulose (0.5 to 4×10⁵ Daltons), and chitosan (0.5 to 4×10⁵ Daltons) Simply based on its highest molecular weight, one may argue that bacterial cell walls should have viscosity even higher than that of diutan gum whose viscosity is the highest among the common polysaccharide VMAs. However, results showed that the viscosity of bacterial cell walls is about half of that of diutan gum. One explanation is with peptidoglycan being such a giant molecule, its solubility in mixing water is not high and the crosslinking by the short peptide side chains which, on the one hand, maintains the integrity of the giant molecule, on the other hand, bound the linear strands of polysaccharide chains and inhibited shear thinning Thus it is not surprising that application of lysozyme to hydrolyze bacterial cell walls significantly increased the apparent viscosity of the cement paste, compared to the unhydrolyzed bacterial cell walls (FIG. 8), potentially by releasing the linear strands from the macro cross-linked structure of native peptidoglycan. In one embodiment one hydrolysis condition, i.e., hydrolysis for 30 min at 37° C., was employed.

Comparison of bacterial cell walls with common polysaccharide VMAs. Results demonstrate that unhydrolyzed and hydrolyzed bacterial cell wall of 0.02% dosages amended in cement paste exhibited apparent viscosity lower than that of diutan gum of the same dosage (FIG. 8). Note that in the study described diutan gum was weighed as dry powder, while bacterial cell walls were weighed as wet weight. Since the apparent viscosity of unhydrolyzed bacterial cell walls is half of that of diutan gum, it is likely that the viscosity modifying effect of unhydrolyzed bacterial cell walls is better than diutan gum if the wet bacterial cell wall contains more than 50% water. Since the viscosity of hydrolyzed bacterial cell walls was found to be closer to that of diutan gum than the unhydrolyzed bacterial cell walls (FIG. 8), hydrolyzed bacterial cell walls if used in the same dosage as dry weight may exhibit higher viscosity than diutan gum. Despite this estimation, existing results strongly suggest that bacterial cell walls are a highly effective VMA comparable to diutan gum.

New Parameters for Estimating the Effectiveness of VMAs.

To estimate the effectiveness of bacterial cell walls in modifying viscosity, a new parameter, the resistance to change of shear rate Rshear, was proposed in this study. Rshear is correlated with both W/C and the dosage of bacterial cell walls. In general, the higher the W/C, the lower the resistance to changes of shear rates. The higher the dosage of bacterial cell walls, the higher the resistance to change of shear rate. For all W/C studied (0.36, 0.4, 0.44, 0.5 in this study) and all dosages of bacterial cell walls (0.068% and 0.34% in this study), bacterial cell walls could effectively resist the changes in shear rate. For example, Rshear for bacterial cell walls of 0.34% were little changed, at 30 mPa·s2, for W/C of 0.36 and 0.4, in comparison to control without bacterial cell wall which had much bigger changes (FIG. 7). In other words, in the presence of bacterial cell walls, the apparent viscosity decreases with less extent in response to increase of shear rates. With the similarity of chemical structure bacterial cell walls to that of the polysaccharide VMAs, such parameter Rshear could be used to quantify the extent of shear thinning property of these VMAs.

Other Properties of Bacterial Cell Walls as a Concrete Admixture.

Certain embodiments of the invention add cell walls as a concrete admixture to improve the mechanical performance of concrete. Bacterial cell walls in hardened concrete can increase the compressive strength of concrete of 0.3 W/C at day 28 but not day 7 of curing, by increasing CaCO₃ formation from Ca(OH)₂ in concrete.

Strains and Preparation of Dead Cells and Bacterial Cell Walls Admixture to Improve the Mechanical Performance of Concrete.

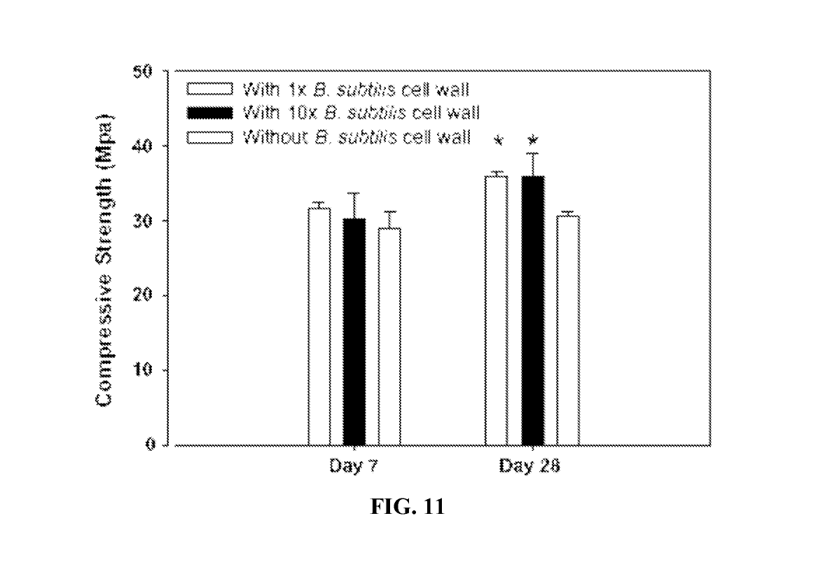

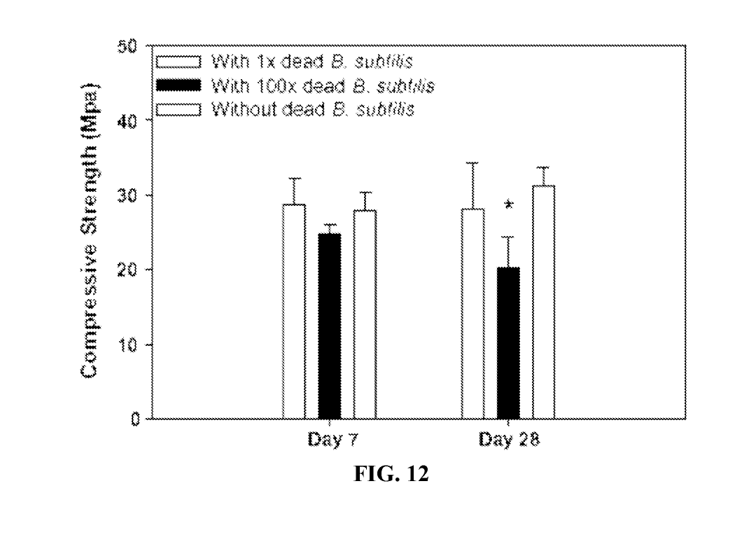

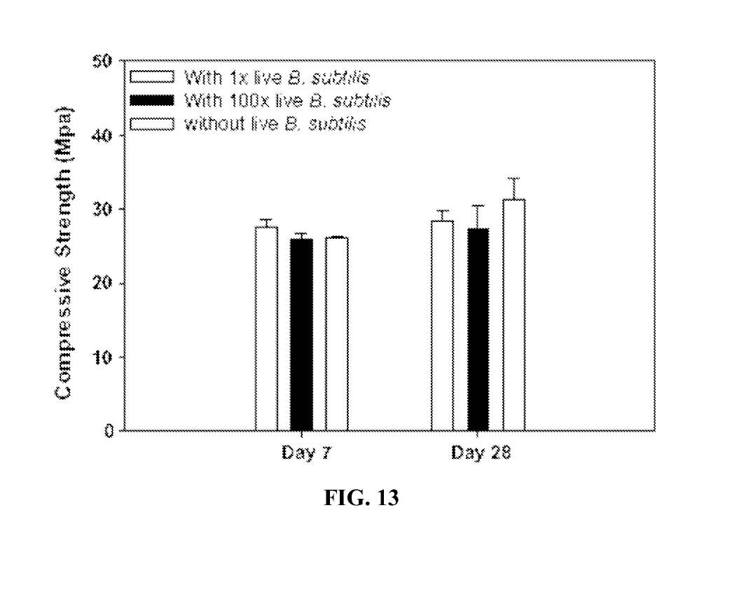

Cell walls, dead, or live cells of B. subtilis were added to cement mortar specimens and the effects were compared with control specimens without adding any bacterial reagents. At day 28 of curing, cell walls of B. subtilis amended at 3.3 mg/ml (10×) and 0.33 mg/ml (1×) concentration caused significant increase of compressive strength by 15.6% and 14.8%, respectively, in comparison with the control specimens (FIG. 11). In contrast, dead cells amended at 3.3 mg/ml concentration did not significantly affect the compressive strength at either the early (day 7) or late stage (day 28) of curing process. Dead cells added at the concentration of 33.3 mg/ml (100×) even significantly decreased the compressive strength at day 28 but not at day 7 (FIG. 12). When live cells were added to concrete at 0.33 mg/ml (1×) or 33.3 mg/ml (100×) concentration, compressive strength was slightly decreased at day 28, although not significantly different than the control (FIG. 13). Overall, the dead and live cells of B. subtilis had no positive effects on the compressive strengths of the cement mortar specimens while the cell wall of B. subtilis increased the compressive strength.

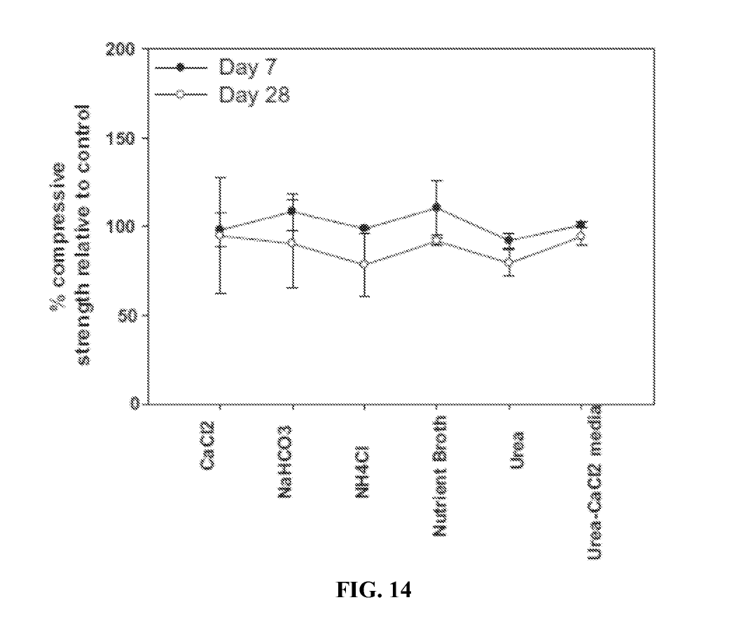

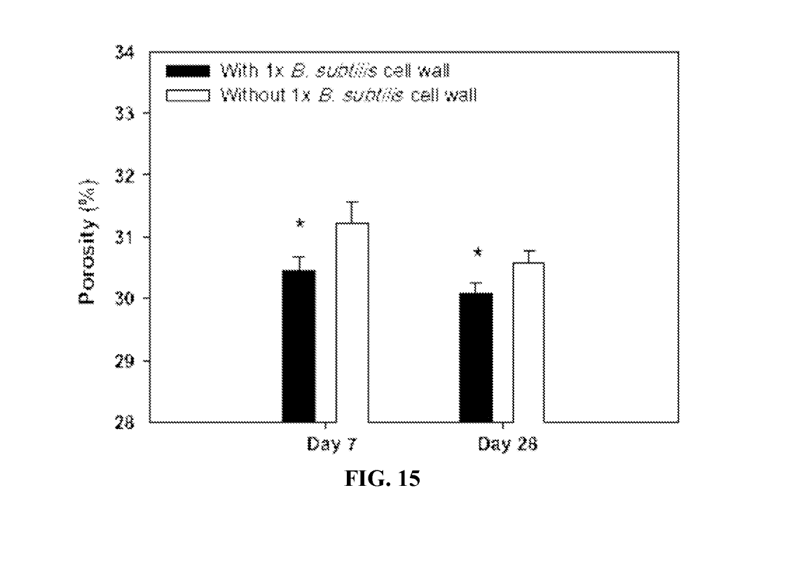

Liquid media (urea-CaCl₂) were added to the cement mortar specimens whenever live B. subtilis cells were added, similar to previous reports (Chetty et al., Infect Immun, 38 (1982) 1010-19). When the effects of cell walls of B. subtilis, or dead B. subtilis cells were studied, to be consistent with studies using live B. subtilis cells, liquid media were also added. One issue for such experimental design is that the liquid media (urea-CaCl₂) may interfere with the effect of the bacterial reagents. Thus the compressive strength of concrete specimens amended only with the liquid media or individual components of the liquid media was measured. Compared to the control specimens amended with only water, components of the media (calcium chloride, sodium bicarbonate, ammonium chloride, nutrient broth, and urea) or the liquid media at the concentration levels used in the study of bacterial reagents had no statistically significant effect on the compressive strengths (FIG. 14). Having found cell walls to be the bacterial reagent that had a positive effect on the compressive strength and had the potential to solve the issues of concrete incorporating live bacteria, the inventors performed further study on the effects of bacterial cell walls on concrete porosity using gas displacement pycnometry. The results indicated that porosity decreased in the presence of cell walls of B. subtilis significantly by 2.47% and 1.64% on average at day 7 and 28 of curing, respectively (FIG. 15).

Effects of Cell Walls, Dead Cells and Peptidoglycan of Other Bacteria.

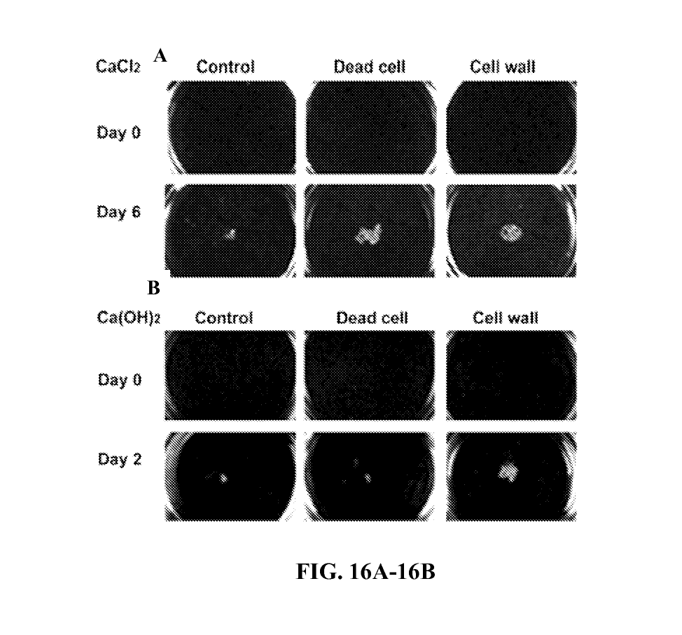

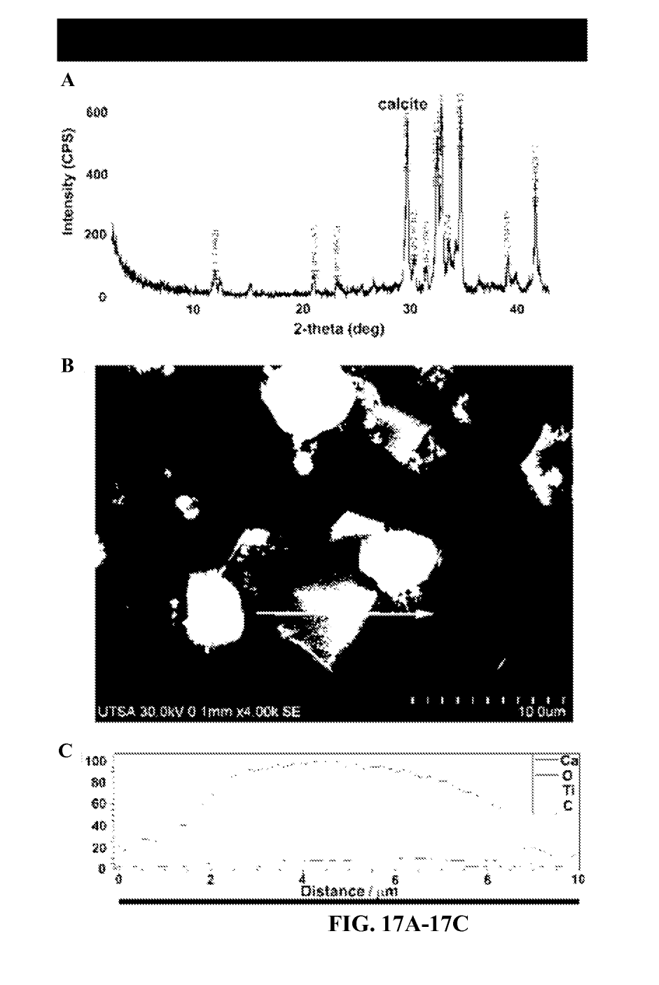

Bacteria of diverse species are capable of forming CaCO₃ crystal in MICP (Vollmer et al., FEMS microbiology reviews, 32 (2008) 149-67; Cheong et al., Arch Pharm Res, 22 (1999) 515-19). Having shown the effects of cell walls of B. subtilis to increase CaCO₃ formation in concrete (FIG. 17) and in solution (FIG. 16), the inventors wanted to know whether cell walls of other bacteria have similar effects and what the effective components of cell walls are. Therefore, cell walls of Gram positive (B. subtilis or M. luteus), negative bacteria (E. coli), the dead cells of these bacteria, or purified peptidoglycan of B. subtilis, which is a major biochemical component in cell wall, were compared in the in vitro CaCO₃ precipitation assay. The cell walls of all Gram positive (M. luteus) and negative bacteria (E. coli), similarly to the cell walls of B. subtilis, accelerated CaCO₃ formation in Ca(OH)₂ solution. And the dead cells of Gram positive and negative bacteria, similar to the dead cells of B. subtilis, did not accelerate CaCO₃ formation in Ca(OH)₂ solution (FIGS. 8A and 8B). Similarity of results among all bacteria is consistent with the reports that both Gram positive and negative bacteria are capable of causing CaCO₃ crystal formation in MICP. This suggests that the cell walls of many bacteria, not only those of B. subtilis, may act as bacterial admixtures for modulating concrete properties. Peptidoglycan of B. subtilis did not affect CaCO₃ formation (FIG. 8C), suggesting that other components but not peptidoglycan in cell walls of B. subtilis are responsible for CaCO₃ formation.

Other polysaccharide VMAs have also been observed to affect the compressive strength of hardened concrete. Welan gum or a cellulose ether (hydroxypropyl methyl cellulose), amended in non-air-entrained concrete caused decrease of compressive strength up to 10% for concrete with W/C of 0.3 at day 7 and 28 day of curing. Such reduction was attributed to the higher air content (1 to 2.3%) in concrete amended with the VMAs (Khayat, Aci Mater J, 93 (1996) 134-46). Another cellulose ether, hydroxyethyl cellulose, has been reported to either increase or decrease compressive strength depending on the dosages of VMA (Singh et al., Cement Concrete Res, 33 (2003) 1319-29). VMAs have also been reported to affect other physico-chemical properties of concrete. For example, hydroxyethyl cellulose has been reported to alter tensile strength, fracture toughness, the heat of hydration and corrosion resistance (Singh et al., Cement Concrete Res, 33 (2003) 1319-29). Welan gum or hydroxypropyl methyl cellulose amended in non-air-entrained concrete caused decrease of flexural strength in concrete with 0.3W/C (Khayat, Aci Mater J, 93 (1996) 134-46). Another cellulose ether, carboxymethyl cellulose, caused decrease of water absorption and increase of corrosion resistance (Mishra et al., Mat Sci Eng a-Struct, 357 (2003) 13-19). Starch and cellulose ethers (hydroxyethyl, methyl, and hydroxymethyl cellulose) caused retardation of cement hydration (Peschard et al., J Eur Ceram Soc, 26 (2006) 1439-45; Peschard et al., Cement Concrete Res, 34 (2004) 2153-58).

For cement paste with W/C of 0.36, 0.4, 0.44 or 0.5, bacterial cell walls of 0.068% or 0.34% dosages increased the viscosity of cement paste, compared to that of the control cement without bacterial cell wall, and the viscosity decreased with increase of shear rates. The extent of shear thinning is positively correlated with the dosage of bacterial cell walls, similar to what has been observed in other common VMA modified system.

The molecular weight of bacterial cell walls was modified upon lysozyme hydrolysis. Under hydrolysis conditions of 30 min treatment at 37° C., hydrolyzed bacterial cell walls exhibited higher viscosity than the unhydrolyzed bacterial cell walls. The viscosity enhancing activities of hydrolyzed and unhydrolyzed bacterial cell walls are lower but nonetheless comparable to that of diutan gum.

Since SP is commonly used in conjunction with VMAs, the interaction between a commercial SP of 0.75% or 0.25% dosages and bacterial cell walls was studied. Superplasticizer 1 demonstrated dose-dependent dispersing activity that was compatible with the bacterial cell walls.

TABLE 1

A
Actinobacteria
Actinomyces
Actinomyces georgiae
Actinomyces gerencseriae
Actinomyces israelii
B
Bacillales
Bacillus
Bacillus cereus
Bacillus mojavensis
Bacillus weihenstephanensis
C
Clostridium
Clostridium acetobutylicum
Clostridium aerotolerans
Clostridium argentinense
Clostridium
autoethanogenum
Clostridium baratii
Clostridium beijerinckii
Clostridium bifermentans
Clostridium botulinum
Clostridium butyricum
Clostridium cadaveris
Clostridium cellobioparum
Clostridium cellulolyticum
Clostridium cellulovorans
Clostridium chauvoei
Clostridium clostridioforme
Clostridium colicanis
Clostridium difficile
Clostridium estertheticum
Clostridium fallax
Clostridium formicaceticum
Clostridium histolyticum
Clostridium innocuum
Clostridium kluyveri
Clostridium ljungdahlii
Clostridium novyi
Clostridium paradoxum
Clostridium paraputrificum
Clostridium perfringens
Clostridium phytofermentans
Clostridium piliforme
Clostridium ragsdalei
Clostridium ramosum
Clostridium
saccharobutylicum
Clostridium
saccharoperbutylacetonicum
Clostridium scatologenes
Clostridium septicum
Clostridium sordellii
Clostridium sporogenes
Clostridium stercorarium
Clostridium sticklandii
Clostridium tertium
Clostridium tetani
Clostridium
thermosaccharolyticum
Clostridium tyrobutyricum
Clostridium uliginosum
Corynebacterium
Corynebacterium
amycolatum
Corynebacterium bovis
Corynebacterium diphtheriae
Corynebacterium granulosum
Corynebacterium jeikeium
Corynebacterium
minutissimum
Corynebacterium renale
D
Desulfitobacterium
dehalogenans
E
Enterococcus
F
Fervidobacterium
changbaicum
Fervidobacterium
gondwanense
G
Georgenia ruanii
L
Lactobacillales
Listeria
Listeriaceae
M
Micrococcus
Micrococcus luteus
N
Nocardia
Nocardia asteroides
Nocardia brasiliensis
Nocardia farcinica
Nocardia ignorata
P
Pasteuria
Propionibacterium acnes
R
Rhodococcus equi
S
Sarcina (genus)
Solobacterium moorei
Sporulation in Bacillus
subtilis
Staphylococcus
Staphylococcus aureus
Staphylococcus capitis
Staphylococcus caprae
Staphylococcus epidermidis
S cont.
Staphylococcus haemolyticus
Staphylococcus hominis
Staphylococcus lugdunensis
Staphylococcus muscae
Staphylococcus nepalensis
Staphylococcus pettenkoferi
Staphylococcus
pseudintermedius
Staphylococcus
saprophyticus
Staphylococcus schleiferi
Staphylococcus succinus
Staphylococcus warneri
Staphylococcus xylosus
Streptococcus
Streptococcus agalactiae
Streptococcus anginosus
Streptococcus bovis
Streptococcus canis
Streptococcus gordonii
Streptococcus iniae
Streptococcus lactarius
Streptococcus mitis
Streptococcus mutans
Streptococcus oralis
Streptococcus parasanguinis
Streptococcus peroris
Streptococcus pneumoniae
Streptococcus pyogenes
Streptococcus ratti
Streptococcus salivarius
Streptococcus sanguinis
Streptococcus sobrinus
Streptococcus suis
Streptococcus thermophilus
Streptococcus uberis
Streptococcus vestibularis
Syntrophomonas curvata
Syntrophomonas palmitatica
Syntrophomonas sapovorans
Syntrophomonas wolfei
Syntrophomonas zehnderi
V
Viridans streptococci

What is claimed is:

1. A concrete composition comprising: cement, an aggregate, water, and bacterial cell walls or bacterial peptidoglycans.

2. The composition of claim 1, wherein the bacterial cell walls or bacterial peptidoglycans are isolated from Gram-positive bacteria.

3. The composition of claim 2, wherein the Gram-positive bacteria is Bacillus subtilis.

4. The composition of claim 1, wherein the bacterial cell walls or bacterial peptidoglycans are about 0.01 to 0.5 weight percent of the composition.

5. The composition of claim 1, wherein the water to cement ratio is about 0.3 to 0.5.

6. The composition of claim 1, further comprising a superplasticizer.

7. The composition of claim 6, wherein the supreplasticizer is 0.25 to 1% weight percent.

8. A method of modifying the viscosity of concrete mixtures comprising adding bacterial cell walls or bacterial peptidoglycans to a cement mixture as a viscosity modifying agent.

9. The method of claim 8, wherein isolated bacterial peptidoglyans are added to the cement mixture.

10. The method of claim 8, wherein the bacterial cell walls or bacterial peptidoglycans are isolated from Gram-positive bacteria.

11. The method of claim 10, wherein the Gram-positive bacteria is Bacillus subtilis.

12. The method of claim 8, wherein the bacterial cell walls or bacterial peptidoglycans are about 0.01 to 0.5 weight percent of the composition.

13. The method of claim 8, wherein the water to cement ratio is about 0.3 to 0.5.

14. The method of claim 8, further comprising adding a superplasticizer.

15. The method of claim 14, wherein the supreplasticizer is 0.25 to 1% weight percent.
